(19) United States
(12) Patent Application Publication
(10) Pub. No.: US 2026/0291305 A1
(43) Pub. Date: Sep. 24, 2026

(54) ROTOR FOR AN ASYNCHRONOUS ELECTRIC MACHINE

(71) Applicant: MAGNA Powertrain GmbH & Co KG, Lannach (AT)

(72) Inventors: Stefan Rechtlehner, Wien (AT); Andreas Zöchbauer, Altenfelden (AT)

(21) Appl. No.: 19/570,701

(22) Filed: Mar. 18, 2026

(30) Foreign Application Priority Data
Mar. 20, 2025 (DE) 10 2025 110 920.6

(51) Int. Cl. H02K 1/26; H02K 17/16

(52) U.S. Cl. CPC H02K 1/265; H02K 17/168

(57) ABSTRACT

A rotor for an asynchronous machine includes a laminated rotor core having a plurality of circumferentially uniformly distributed grooves extending axially through the laminated rotor core, and a cast rotor cage, having a plurality of cage bars extending through the grooves of the laminated rotor core and rotor end rings adjacent to end faces of the laminated rotor core and connecting the cage bars. The laminated rotor core has a plurality of axially stacked rotor laminations each with a plurality of circumferentially uniformly distributed recesses forming the grooves. The rotor laminations are of at least two different lamination types, namely a first lamination type with elongated, radially extending first recesses or a second lamination type with elongated, radially extending second recesses. The radial extent of the first recesses is less than the radial extent of the second recesses, forming a stepped surface at each end of the grooves.

### CROSS-REFERENCE TO RELATED APPLICATIONS

This application claims the benefit of German Patent Application No. DE 10 2025 110 920.6, filed Mar. 20, 2025, the entire content of which is hereby incorporated by reference in its entirety.

### FIELD

The invention relates to a rotor for an asynchronous machine, comprising a laminated rotor core having a plurality of circumferentially uniformly distributed grooves extending axially through the laminated core and a cast rotor cage having a plurality of cage bars extending through the grooves of the laminated rotor core and rotor end rings adjacent to end faces of the laminated rotor core and connecting the cage bars.

### BACKGROUND

Electric asynchronous machines are used, among other things, as drive motors and/or generators in electric or hybrid vehicles. An electric asynchronous machine generally has a stator and a rotor that can rotate relative to the stator. The rotor is designed as a so-called squirrel-cage rotor, which has a cage made of an electrically conductive material such as aluminum or copper or alloys of those materials.

The rotor cage is usually arranged on a laminated rotor core and has longitudinally extending rotor bars and rotor end rings that connect the ends of these rotor bars. Traditionally, the squirrel cage is manufactured either by casting, in which case liquid metal is poured into a mold surrounding the rotor body and flows into grooves provided in the rotor body in order to form the rotor bars while simultaneously flowing into cavities provided on end faces of the rotor body in order to form the rotor end rings. Alternatively, the rotor cage can also be assembled from multiple rods and separate rotor end rings, in which case the aforementioned components are subsequently electrically connected to one another, for example by soldering, welding, or similar methods.

In order to operate electric asynchronous machines at higher speeds and thus increase their power density, the focus of development has been placed particularly on improving the load-bearing capacity of the rotor end rings, because these are subjected to strong centrifugal forces at high speeds which can damage or, in the worst case, destroy the rotor. However, such an improvement in the load-bearing capacity of the rotor end rings usually always entails the need for additional components and/or complex assembly processes and tools.

It is the object of the invention to provide a rotor for an electric asynchronous machine which is characterized in particular by improved load-bearing capacity of the rotor end rings with low component and manufacturing costs.

### SUMMARY

This object is achieved by a rotor for an electric asynchronous machine having the features of claim 1.

According to the invention, the rotor comprises a laminated rotor core having a plurality of circumferentially uniformly distributed grooves extending axially through the laminated rotor core and a cast rotor cage, having a plurality of cage bars extending through the grooves of the laminated rotor core and rotor end rings adjacent to end faces of the laminated rotor core and connecting the cage bars.

The directional indication “axial” describes a direction along or parallel to a central axis of rotation of the rotor.

The term “circumferential” describes a direction following an outer circumference of the rotor or of the laminated rotor core of the rotor.

According to the present invention, the laminated rotor core comprises a plurality of axially stacked rotor laminations, each with a plurality of circumferentially uniformly distributed recesses for forming the respective grooves extending axially through the laminated rotor core.

According to the invention, the rotor laminations can each be associated with at least two different lamination types, namely a first lamination type with elongated first recesses extending in a radial direction or a second lamination type with elongated second recesses extending in a radial direction, the radial extent of the first recesses being less than the radial extent of the second recesses. It would also be conceivable, for example, to develop a third lamination type with which at least one rotor lamination can be associated, the third lamination type having both first and second recesses.

The directional indication “radial” describes a direction normal to the central axis of rotation of the rotor.

According to the present invention, in the laminated rotor core, at least multiple rotor laminations of the second lamination type, then at least multiple rotor laminations of the first lamination type, and then again at least multiple rotor laminations of the second lamination type are stacked on top of one another in the axial direction, so that a first support shoulder is formed in the respective grooves at least in the area of the ends of the laminated rotor core, namely near the end faces, i.e., in the respective vicinity of the respective end face of the laminated rotor core.

The “end faces” are essentially formed by each of the bottom surface and the top surface of the cylindrical or hollow cylindrical laminated rotor core.

The inventive design of the rotor, namely, in particular, the creation of a stepped design of the grooves in the laminated rotor core, makes it possible to significantly reduce the risk of damage to the rotor, for example irreversible deformation of the rotor end rings, at higher speeds, thereby enabling reliable operation of the electric asynchronous machine at the highest possible power density.

The second recesses are also preferably designed such that their width, along the circumferential direction, decreases radially over a defined length starting from an outer circumference of the rotor lamination, and then the circumferential width increases again over a defined length, so that at least one additional second support shoulder is created. Such a design of the second recess, namely in which a second support shoulder is created, enables an additional improvement in the mechanical load-bearing capacity of the rotor of the electric asynchronous machine to be achieved in a simple manner.

The radial extent of each recess preferably corresponds to a range of at least 4% to a maximum of 22% of the outer diameter of the respective rotor lamination.

The radial distance of the respective recess to a central recess of the respective rotor lamination preferably corresponds to at least twice the thickness, namely twice the axial extent, of a respective rotor lamination.

The radial distance of the respective recess to an outer circumference of the respective rotor lamination preferably corresponds to at least twice the thickness, namely twice the axial extent, of a respective rotor lamination.

In one advantageous embodiment of the rotor, the rotor end rings are made of aluminum or copper.

The rotor design according to the invention enables an improved asynchronous machine with a cast rotor cage to be manufactured. In particular, the rotor includes improved load-bearing capacity of the rotor end rings of the cast rotor cage with low component and manufacturing costs.

### BRIEF DESCRIPTION OF THE DRAWINGS

Embodiments of the invention are described in the following with reference to the enclosed figures, but neither the drawings nor the description are to be interpreted as restricting the invention. The figures are merely schematic and not true to scale. Same reference symbols in the figures designate features in the figures that are the same or have a similar effect.

FIG. 1 shows a perspective view of a laminated rotor core of a rotor for an electric asynchronous machine.

FIG. 2a shows a plan view of a first end face of a laminated rotor core according to FIG. 1.

FIG. 2 b shows a detailed view of section C from FIG. 2a.

FIG. 3a shows a plan view of a second end face of a laminated rotor core according to FIG. 1.

FIG. 3b shows a detailed view of section B from FIG. 3 a.

FIG. 4 shows a sectional view along the sectional line A-A according to FIG. 2a.

FIG. 5a shows a plan view of a rotor lamination of a first lamination type.

FIG. 5b shows a detailed view of section D from FIG. 5a.

FIG. 6a shows a plan view of a rotor lamination of a second lamination type.

FIG. 6b shows a detailed view of section E from FIG. 6a.

### DETAILED DESCRIPTION

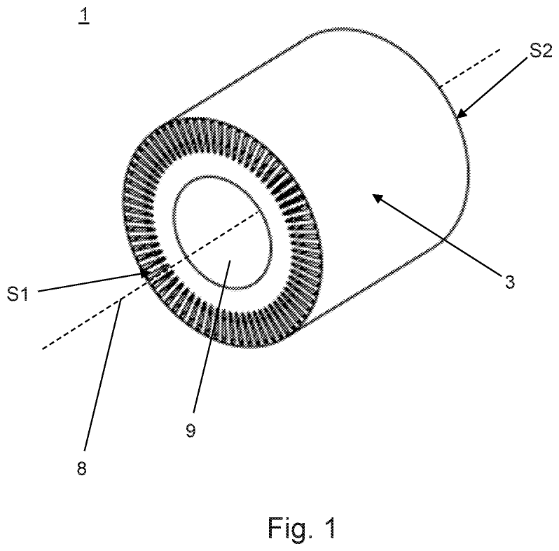

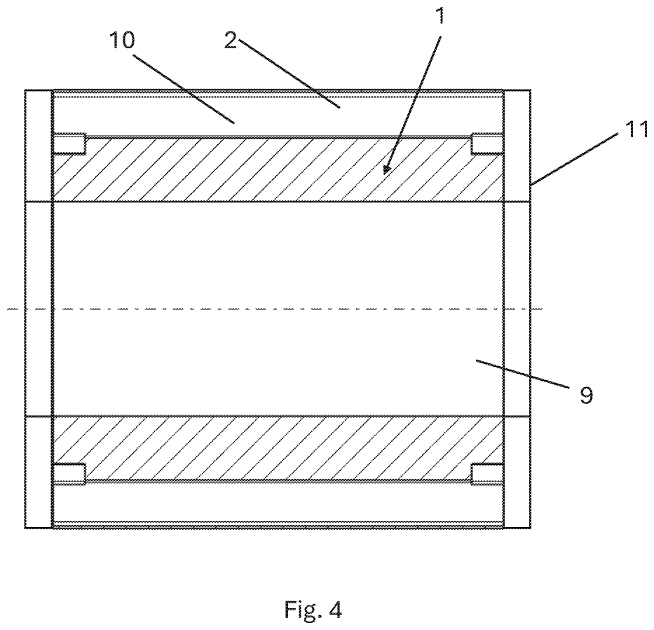

FIG. 1 shows a perspective view of a laminated rotor core 1 of a rotor of an electric asynchronous machine according to the invention. For the sake of clarity, a cast rotor cage of the rotor according to the invention is shown schematically relative to the cross-section of FIG. 4, in which the cast rotor cage is disposed in the grooves 2 formed by the recesses 4 of the stacked laminations 3, with the end rings 11 of the rotor cage disposed at each end face of the rotor core 1 and connecting the cage bars 10 disposed in the grooves 2. The rotor cage is not illustrated in the other figures.

The laminated rotor core 1 is substantially hollow cylindrical with a central opening 9 for receiving a rotor shaft. The laminated rotor core 1 has a plurality of axially stacked, thin lamellar rotor laminations 3. Each rotor lamination 3 is designed with a circular outer circumference and a likewise circular central recess 7. Furthermore, in the present exemplary embodiment, each rotor lamination 3 has a plurality of circumferentially uniformly distributed recesses 4, namely a plurality of circumferentially uniformly distributed first recesses 4a or a plurality of circumferentially uniformly distributed second recesses 4b.

The directional indication “axial” describes a direction along or parallel to a central axis of rotation 8 of the rotor. The directional indication “radial” describes a direction perpendicular to the central axis of rotation 8 of the rotor.

In the present case, each rotor lamination 3 can be associated with a first lamination type 3a or a second lamination type 3b, the two lamination types 3a, 3b differing in the design of the circumferentially uniformly distributed recesses 4. A rotor lamination 3 of the first lamination type 3a has a plurality of circumferentially uniformly distributed, elongated, radially extending first recesses 4a. A rotor lamination 3 of the second lamination type 3b has a plurality of second recesses 4b corresponding to the number of first recesses 4a, evenly distributed around the circumference and extending in a radial direction. The radial extent of the first recesses 4a is less than the radial extent of the second recesses 4b.

The rotor laminations 3 of the first lamination type 3a and the second lamination type 3b are arranged in axially stacked fashion such that the first recesses 4a and the second recesses 4b are aligned with one another in order to form grooves 2 which extend in the longitudinal direction of the laminated rotor core 1, i.e., axially, and are spaced apart from one another in the circumferential direction U of the laminated rotor core 1. These grooves 2 primarily serve to accommodate the cage bars 10 of the rotor cage that extend between the end rings 11 at each end face (see FIG. 4).

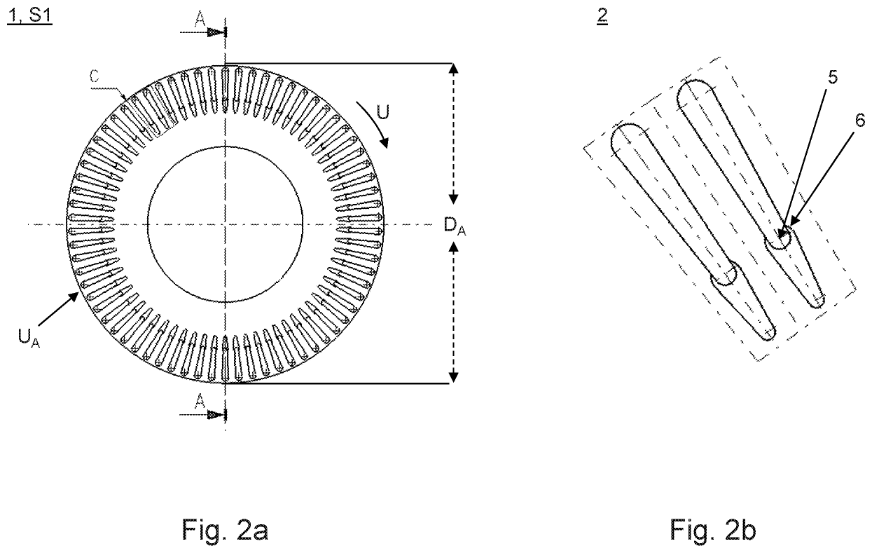

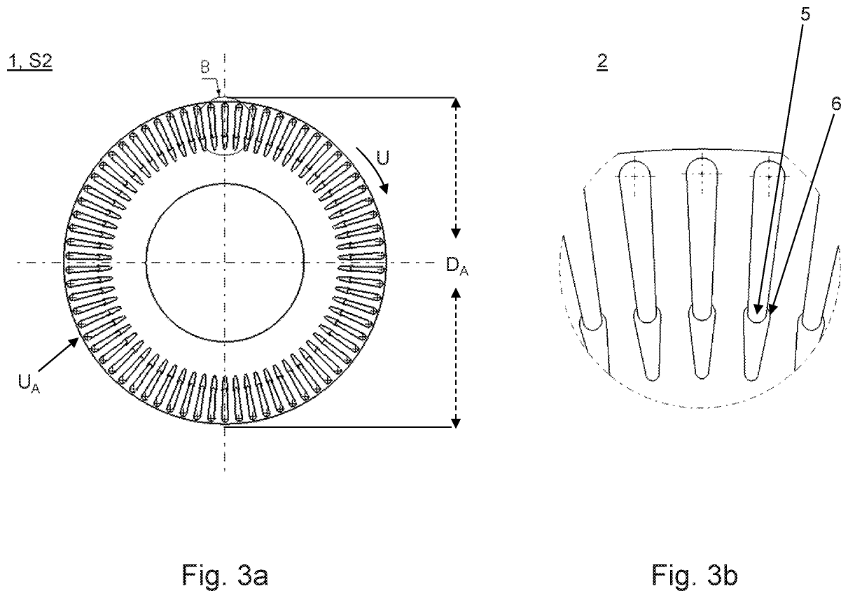

The exemplary embodiment of the laminated rotor core 1 shown in FIG. 1 to FIG. 4 in different levels of detail is formed by axially stacking a plurality of rotor laminations 3 of the second lamination type 3b at one end, then axially stacking a plurality of rotor laminations 3 of the first lamination type 3a, and then again axially stacking a plurality of rotor laminations 3 of the second lamination type 3a at the other end. In this way, a first support shoulder 5 is formed in the respective grooves 2 in the area of the ends of the laminated rotor core 1, namely near the end faces.

The term “near the end face” describes an area near a first end face S1 or a second end face S2 of the laminated rotor core 1. The first end face S1 forms a bottom surface of the hollow cylindrical laminated rotor core 1; the second end face S2 forms a top surface of the hollow cylindrical laminated rotor core 1.

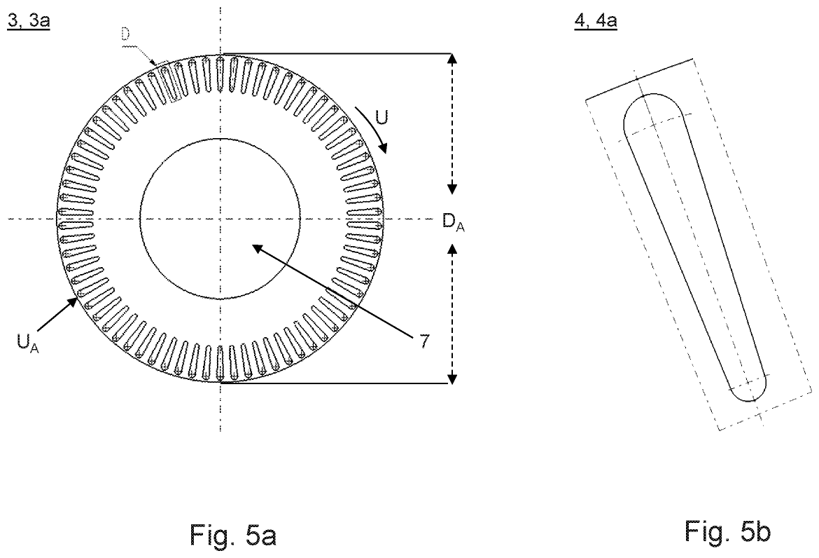

FIGS. 5a and 5b show a rotor lamination 3 of the first lamination type 3a in different levels of detail. The first recesses 4a are designed such that their width along the circumferential direction U (circumferential width) decreases radially, in a radial direction, over a defined radial length starting from an outer circumference U_{A} of the respective rotor lamination 3 of the first lamination type 3a.

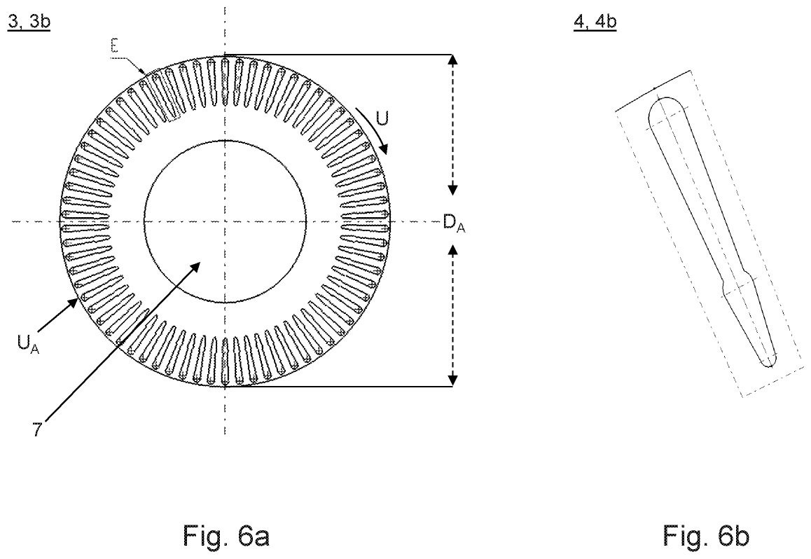

FIGS. 6a and 6b show a rotor lamination 3 of the second lamination type 3b in different levels of detail. The second recesses 4b are designed such that their width along the circumferential direction U decreases in the radial direction radially over a defined length starting from an outer circumference U_{A} of the respective rotor lamination 3 of the second lamination type 3b and then increases again over a defined length. A further support shoulder, namely a second support shoulder 6, can thus be generated by axially stacking a plurality of rotor laminations 3 of the second lamination type 3b.

The outer diameter D_{A} and the outer circumference U_{A} of the rotor lamination 3 of the first lamination type 3a correspond to the outer diameter D_{A} and the outer circumference U_{A} of the rotor lamination 3 of the second lamination type 3b. The outer diameter D_{A} and the outer circumference U_{A} of the laminated rotor core 1 thus correspond to the outer diameter D_{A} and the outer circumference U_{A} of the axially stacked rotor laminations 3, 3a, 3b.

### REFERENCE NUMBERS

1 laminated rotor core
2 groove
3 rotor lamination
3a first lamination type (rotor lamination of the first lamination type)
3b second lamination type (rotor lamination of the second lamination type)
4 recess
4a first recess
4b second recess
5 first support shoulder
6 second support shoulder
7 central recess (of the respective rotor lamination)
8 central axis of rotation (of the rotor)
9 central opening (of the laminated rotor core)
10 cage bar
11 end ring
S1 first end face (of the laminated rotor core)
S2 second end face (of the laminated rotor core)
D_{A} outer diameter (of the respective rotor lamination or laminated rotor core)
U_{A} outer circumference (of the respective rotor lamination or laminated rotor core)
U circumferential direction (of the respective rotor lamination or laminated rotor core)

What is claimed is

1. A rotor for an asynchronous machine, comprising:
a laminated rotor core having a plurality of circumferentially uniformly distributed grooves extending axially through the laminated rotor core and
a cast rotor cage, having a plurality of cage bars extending through the grooves of the laminated rotor core and rotor end rings adjacent to end faces of the laminated rotor core, the end rings connecting the cage bars,
wherein the laminated rotor core has a plurality of axially stacked rotor laminations each having a plurality of circumferentially uniformly distributed recesses forming the grooves,
wherein the axially stacked rotor laminations include at least two different lamination types, including a first lamination type with elongated, radially extending first recesses or a second lamination type with elongated, radially extending second recesses,
wherein the radial extent of the first recesses is less than the radial extent of the second recesses and
wherein, in the laminated rotor core, at least multiple rotor laminations of the second lamination type, then at least multiple rotor laminations of the first lamination type, and then again at least multiple rotor laminations of the second lamination type are stacked on top of one another in the axial direction, such that that a first support shoulder is defined in the respective grooves at least at end regions of the laminated rotor core.

2. The rotor according to claim 1,
wherein the second recesses have a width, along the circumferential direction, that decreases radially from an outer circumference of a respective rotor lamination of the second lamination type over a defined radial length and then increases over a defined radial length, such that at least one second support shoulder is defined in the laminated rotor core.

3. The rotor according to claim 1,
wherein a radial extent of a respective recess of the first and second recesses is within a range of 4% to 22% of an outer diameter of a respective rotor lamination of the axially stacked rotor laminations.

4. The rotor according to claim 1,
wherein a radial distance of a respective recess of the first and second recesses to a central recess of a respective rotor lamination of the axially stacked rotor laminations is at least twice an axial extent of the respective rotor lamination.

5. The rotor according to claim 1,
wherein a radial distance of a respective recess of the first and second recesses to an outer circumference of a respective rotor lamination of the axially stacked rotor laminations is at least twice an axial extent of the respective rotor lamination.

6. The rotor according to claim 1, wherein the rotor end rings are made of aluminum or copper.

7. The rotor according to claim 1, wherein the first support shoulder is defined in the respective grooves at least at end regions of the laminated rotor core.

8. The rotor according to claim 1,
wherein the second recesses have a width, along the circumferential direction, that decreases in a radial direction from an outer circumference of the respective rotor lamination of the second lamination type over a defined radial length and then increases over a defined radial length, such that at least one second support shoulder is defined in the laminated rotor core,
wherein a radial distance of the respective recess of the first and second recesses to a central recess of the respective rotor lamination of the axially stacked rotor laminations is at least twice an axial extent of the respective rotor lamination.
wherein a radial distance of a respective recess of the first and second recesses to an outer circumference of the respective rotor lamination of the axially stacked rotor laminations is at least twice the axial extent of the respective rotor lamination.

9. The rotor according to claim 1, wherein the groove defined by the laminations has end portions at each end face that are radially longer relative to an intermediate section extending axially between the end portions of the groove.

10. The rotor according to claim 1, wherein each groove has a stepped shape, wherein the first support shoulder is defined by the stepped shape.

11. The rotor according to claim 1, wherein each groove has a radially outer end extending along a consistent radial dimension axially through the laminated rotor core.

12. The rotor according to claim 11, wherein each groove has a radially inner end that varies along the axial length of the laminated rotor core.

13. The rotor according to claim 12, wherein the radially inner end is closer to the central axis at the end faces relative to an axially intermediate section of groove.

14. The rotor according to claim 1, wherein an axial length of the laminated rotor core having the first recesses is greater than an axial length of the laminated rotor core having the second recesses.

15. The rotor according to claim 1, wherein each groove is enlarged at end portions of the groove at each axial end of the laminated rotor core relative to an intermediate section of the groove that extends axially between the end portions.

16. The rotor according to claim 15, wherein the end portions of each groove have the same axial length.
